(19) United States
(12) Patent Application Publication
(10) Pub. No.: US 2009/0001724 A1
(43) Pub. Date: Jan. 1, 2009

(54) METHOD AND APPARATUS FOR CONTROLLING VERTICAL AXIS WIND POWER GENERATION SYSTEM

(75) Inventors: Seung Bae LEE, Seoul (KR); Jeoung Ik JANG, Seoul (KR)

Correspondence Address: Jason Y. Pahng and Associates, LLC, 12178 Bridgend Run, Fairfax, VA, 22030, US

(73) Assignee: KR CO., LTD., Pyeongtaek-city (KR)

(21) Appl. No.: 12/144,644

(22) Filed: Jun. 24, 2008

(30) Foreign Application Priority Data
Jun. 26, 2007 (KR) 10-2007-0062798

(51) Int. Cl. F03D 7/06; F03D 3/00; F03D 9/00

(52) U.S. Cl. 290/44; 416/23; 416/25; 416/32

(57) ABSTRACT

Provided are an apparatus and method for controlling a vertical axis wind power generation system that controls the rotation of guide vanes according to wind direction and speed, appropriately controls a direction of wind passing over an impeller, thereby maintaining a rotational speed generating the maximum power, maintains output power of a generator as rated power according to wind direction and speed, and stops the generator when a low or high wind speed outside a setting value range, an error in a structure, a fault in a braking unit, and/or a fault in guide vanes is detected.

### CROSS-REFERENCE TO RELATED PATENT APPLICATION

This application claims the benefit of Korean Patent Application No. 10-2007-0062798, filed on Jun. 26, 2007, in the Korean Intellectual Property Office, the disclosure of which is incorporated herein in its entirety by reference.

### BACKGROUND OF THE INVENTION

1. Field of the Invention

The present invention relates to an apparatus and method for controlling a vertical axis wind power generation system, and more particularly, to an apparatus and method for controlling a vertical axis wind power generation system, which controls rotation of guide vanes included in the vertical axis wind power generation system having a vertical axis turbine, and appropriately adjusts a direction of wind that has entered the vertical axis wind power generation system so as to pass over a rotor blade, thereby maintaining a rotation speed and generating the maximum power.

2. Description of the Related Art

In general, wind power generation systems are separated into two types based on the axis around which a turbine rotates, i.e., horizontal-axis wind turbines and vertical-axis wind turbines. Vertical-axis wind turbines are Darrieus wind turbines and Savonius wind turbines. Darrieus wind turbines use lift, whereas Savonius wind turbines use drag. Darrieus wind turbines have a theoretical efficiency of up to 35%.

Vertical-axis wind turbines can utilize winds irrespective of the wind direction, and can set a lower cut-in speed (a minimum wind speed capable of starting power generation) than that of horizontal-axis wind turbines, thereby generating wind power at a slow speed. Thus, vertical-axis wind turbines that are less influenced by the wind direction and have a lower cut-in speed are suitable for a place where the wind speed varies due to greater changes in weather.

FIG. 1A is a schematic plan view of a conventional Savonius drag type vertical-axis wind turbine, which shows a torque of the vertical-axis wind turbine according to the location of an impeller.

Referring to FIG. 1A, in the conventional Savonius drag type vertical-axis wind turbine, locations L₁, L₂, and L₃ of the vanes, over which the wind passes, change so that a relative wing speed W and direction of an incident relative wind change, thus varying the amount of torque. A horizontal-axis wind turbine generates a positive torque in all blades irrespective of the rotational location of the blades, whereas in the Savonius drag type vertical-axis wind turbine there is a location where a negative torque occurs, thus causing an overall lower power coefficient value. For example, in FIG. 1A, negative torque occurs at the location L₃.

Although a closed passage type impeller converts a speed energy incident on the vanes into pressure, and thus the torque size is proportional to the square of the speed, the Savonius drag type vertical-axis wind turbine cannot control a wind speed incident on the vane.

To this end, WO 2004/018872 and Korean Patent application No. 2005-0034732 disclose devices for increasing an incident wind speed by installing a vertical turbine having distributed fixed guide vanes disposed radially around its circumference and inlet guide vanes of various types in an upstream portion (an inlet through which wind enters) of an impeller.

However, since the conventional Savonius drag type vertical-axis wind turbine has a large efficiency fluctuation according to a vane tip rotational speed ratio, it is necessary to increase the incident wind speed by installing the inlet guide vanes and to properly control the number of rotations of the impeller according to a measured incident wind speed of the impeller.

FIG. 1B is a schematic diagram of the distribution of streamlines around an impeller of a jet-wheel type turbine having vertical inlet guide vanes according to the conventional art. FIG. 1C is a diagram of the wind distribution of air flow when the vertical flat type inlet guide vanes are installed according to the conventional art.

Referring to FIG. 1B, streamlines are generated due to the installation of the vertical flat type inlet guide vanes in an upstream portion of the impeller in the conventional Savonius drag type vertical-axis wind turbine, and streamlines are concentrated on the right side of the impeller due to the rotation of the impeller.

Referring to FIG. 1C, inspite of a large inlet/outlet area ratio (about 3.83) of the inlet guide vanes, not all the wind flows into the inlet since some air flows out toward an area of lower resistance, so that the increase in flow speed due to the large inlet/outlet area ratio of the inlet guide vanes is not achieved.

### SUMMARY OF THE INVENTION

The present invention provides an apparatus and method for controlling a vertical axis wind power generation system that controls the rotation of guide vanes according to wind direction and speed, and appropriately controls a direction of wind passing over an impeller, thereby maintaining a rotational speed generating the maximum power.

The present invention also provides an apparatus and method for controlling a vertical axis wind power generation system that checks output power of a generator according to wind direction and speed, maintains rated power, and stops the generator when a low or high wind speed outside a predetermined range of set values, a structural error, a fault in a braking unit, and/or a fault in guide vanes are detected, thereby protecting the vertical axis wind power generation system.

According to an aspect of the present invention, there is provided an apparatus for controlling a vertical axis wind power generation system comprising an anemoscope/anemometer that measures a wind direction and speed, a vertical impeller having a plurality of vanes, one or more guide vanes that guide incident wind and makes the wind flow over the impeller, and a generator that generates power by the rotation of the impeller due to the wind, and for controlling an amount of the wind incident to the impeller based on data received from the anemoscope/anemometer, the apparatus comprising: one or more structure sensors sensing displacements of structures supporting each of a plurality of units of the vertical axis wind power generation system; guide vane driving/braking units rotation-driving or braking the one or more guide vanes and controlling the amount of the wind incident to the impeller; a controller receiving data of the wind direction and speed from the anemoscope/anemometer, sending a signal for controlling the one or more guide vanes to the guide vane driving/braking units so that the generator can generate a previously determined maximum power, and, if each piece of data received from the anemoscope/anemometer, the one or more structure sensors, or the generator is outside a previously established value range, generating a braking signal in the one or more guide vanes, the generator, or the impeller or generating a control signal for mechanically connecting or disconnecting the generator and the impeller; and one or more braking units stopping the generator, the impeller, and the guide vanes according to the control signal for stopping the generator, the control signal for stopping the impeller, or the control signal for stopping the one or more guide vanes that are received from the controller.

Here, the one or more guide vanes preferably comprise inlet guide vanes and lateral side guide vanes,

According to another aspect of the present invention, there is provided a method of controlling a vertical axis wind power generation system that guides incident wind to a vertical axis impeller by receiving current data of a wind direction and speed measured by an anemoscope/anemometer, calculating the current data, and controlling a position movement of one or more guide vanes in a controller, drives a generator by the rotation power of the impeller rotating due to the incident wind, and generates power, the method comprising: a standstill process of, when a current wind speed is lower than a minimum wind speed for preparing for the driving of the generator or is higher than a maximum wind speed for stopping the power generation according to the data of the wind speed received by the controller from the anemoscope/anemometer, braking the one or more guide vanes, the impeller or the generator wherein the controller performs the braking, and mechanically disconnecting the generator and the impeller; a waiting process of, when the current wind speed received by the controller is maintained between a minimum wind speed for starting the power generation and a maximum wind speed for preparing for the stopping of the generator, braking the one or more guide vanes, the impeller or the generator, and moving the one or more guide vanes in accordance with a main wind direction, so that wind having the highest efficiency can flow over the impeller; a partial load operation process, after the waiting process, of mechanically connecting the generator and the impeller, and, when the current wind speed is lower than a wind speed for generating rated power, moving the one or more guide vanes in accordance with the main wind direction so as to generate the maximum power at the current wind speed; a full load operation process of, when the power generated by the generator is higher than the rated power, moving the one or more guide vanes and limiting the wind flowing over the impeller so as to maintain the rated power; and a stopping process of, when the controller detects a fault in at least one of a plurality of units or when the current wind speed is not maintained between the minimum wind speed for preparing for the driving of the generator and the maximum wind speed for stopping the power generation during each process, entering a stop mode in which each unit is stopped.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic plan view of a conventional Savonius drag type vertical-axis wind turbine, which shows a torque of the vertical-axis wind turbine according to the location of an impeller;

FIG. 1B is a schematic diagram of the distribution of streamlines around an impeller of a jet-wheel type turbine having vertical flat type inlet guide vanes according to the conventional art;

FIG. 1C is a diagram of the wind distribution of air flow when the vertical flat type inlet guide vanes are installed according to the conventional art;

FIG. 2 is a block diagram of an apparatus for controlling a vertical axis wind power generation system according to an embodiment of the present invention;

FIG. 3 is a diagram of an operation process according to a change in wind speed in a vertical axis wind power generation system according to an embodiment of the present invention;

FIG. 4 is a schematic flowchart illustrating a process of controlling a vertical axis wind power generation system according to an embodiment of the present invention;

FIG. 5 is a detailed flowchart illustrating the standstill process shown in FIG. 4;

FIG. 6 is a detailed flowchart illustrating the waiting process shown in FIG. 4;

FIG. 7 is a detailed flowchart illustrating the running process shown in FIG. 4;

FIG. 8 is a detailed flowchart illustrating a partial load operation process shown in FIG. 7;

FIG. 9 is a detailed flowchart illustrating a full load operation process shown in FIG. 7;

FIG. 10 is a flowchart illustrating a method of controlling a vertical axis wind power generation system in a low wind speed stop mode according to an embodiment of the present invention;

FIG. 11 is a flowchart illustrating a method of controlling a vertical axis wind power generation system in a braking unit stop mode according to an embodiment of the present invention;

FIG. 12 is a flowchart illustrating a method of controlling a vertical axis wind power generation system in a high wind speed stop mode according to an embodiment of the present invention;

FIG. 13 is a flowchart illustrating a method of controlling a vertical axis wind power generation system in a generator stop mode according to an embodiment of the present invention; and

FIG. 14 is a flowchart illustrating a method of controlling a vertical axis wind power generation system in a guide vane stop mode according to an embodiment of the present invention.

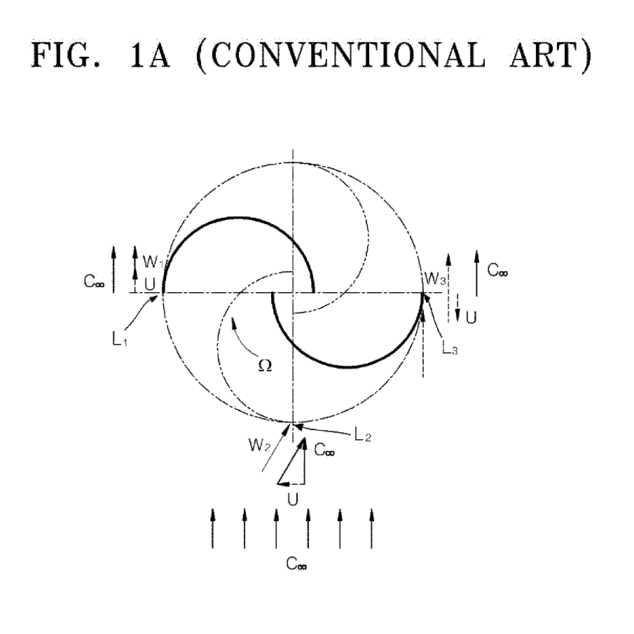

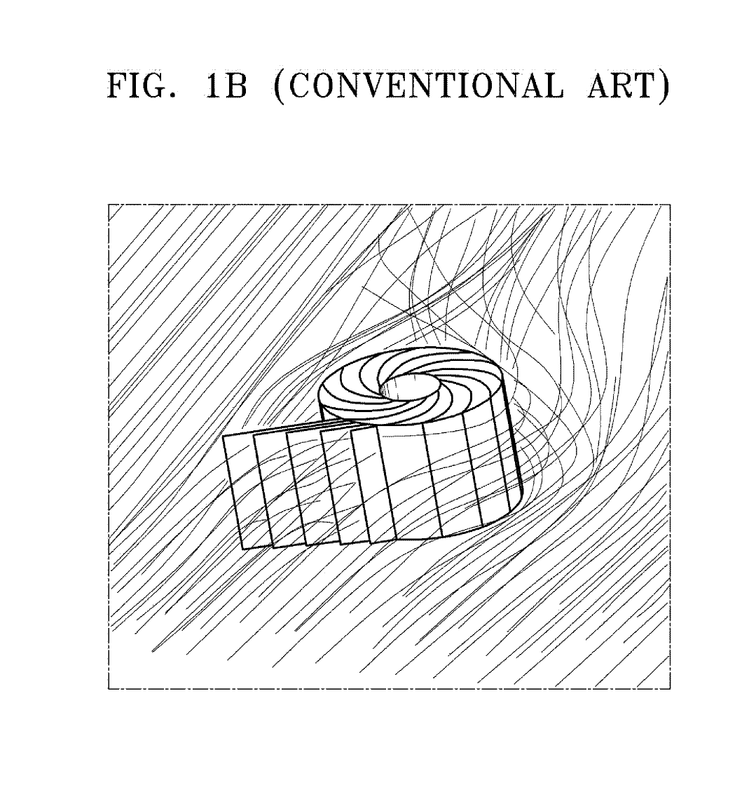

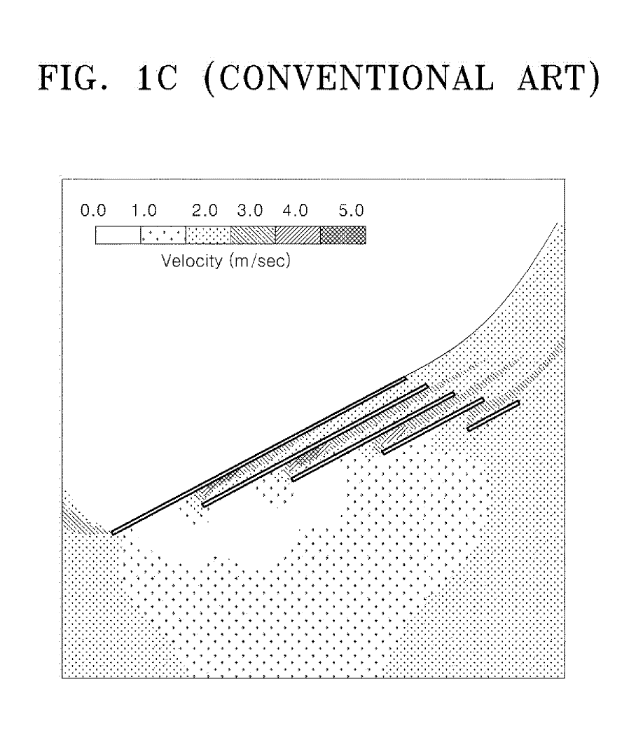

### DETAILED DESCRIPTION OF THE INVENTION

The present invention will now be described more fully with reference to the accompanying drawings, in which exemplary embodiments of the invention are shown.

Meanwhile, a detailed structure of the vertical axis wind power generation system referred by the present invention is disclosed in the Korean Patent Publication No. 810990 (published on 11 Mar., 2008) that is patented to the applicant of this patent application. Hereinafter, the apparatus and the method for controlling the vertical axis wind power generation system according to the present invention will be described in reference to the disclosure of the structure of the vertical axis wind power generation system in the above Korean Patent Publication.

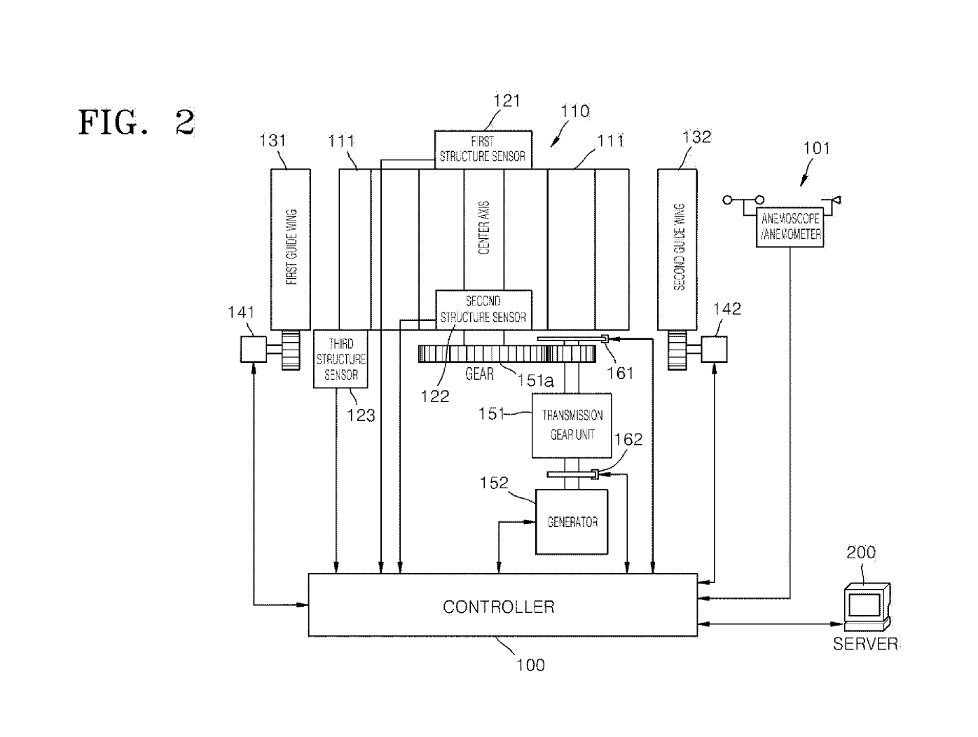

FIG. 2 is a block diagram of an apparatus for controlling a vertical axis wind power generation system according to an embodiment of the present invention. Referring to FIG. 2, the apparatus for controlling the vertical axis wind power generation system of the present embodiment comprises an anemoscope/anemometer 101 that measures wind direction and speed, a vertical axis impeller 110 having a plurality of vanes 111, first and second guide vanes 131 and 132 that guide incident wind and cause the wind to flow into the impeller 110, a transmission gear unit 151 that transmission-rotates by the rotation of the impeller 110 in connection with a gear 151a, a generator 152 that receives a rotational power from the transmission gear unit 151 and generates power, first through third structure sensors 121 through 123 that detect displacements of structures supporting each unit of the vertical axis wind power generation system, which may occur due to stress caused by adverse external conditions, first and second guide vane driving/braking units 141 and 142 that rotation-drive or brake the first and second guide vanes 131 and 132 according to a control signal and control the amount of wind amount passing over the impeller 110, and a controller 100 that receives wind direction and speed data from the anemoscope/anemometer 101 and sends the control signal to the first and second guide vane driving/braking units 141 and 142 so that the generator 152 generates the previously determined maximum power.

The apparatus for controlling the vertical axis wind power generation system of the present embodiment comprises a main braking unit 161 that stops the rotation of the impeller 110 and an auxiliary braking unit 162 that stops the rotation of the transmission gear unit 151 and the generator 152. The main braking unit 161 is disposed between the impeller 110 and the transmission gear unit 151, and, if the controller 100 outputs the control signal to stop the generator 152 and the impeller 110, stops the generator 152 and the impeller 110 according to the control signal. The auxiliary braking unit 162 is disposed between the transmission gear unit 151 and the generator 152, and stops the transmission gear unit 151 and the generator 152 according to a braking control signal of the controller 100.

A server 200 remotely receives status data of each unit, which was received by the controller 100 and control instruction data used by the controller 100, from the controller 100, stores and monitors the status data and the control instruction data. The server 200 can perform remote control through the controller 100.

The controller 100 calculates wind speed data received from the anemoscope/anemometer 101, and, if the calculated wind speed data is within a previously determined wind speed range in which power generation is possible, the controller 100 controls the speed of the generator 152 in order to generate the previously determined maximum power. If each piece of data received from the anemoscope/anemometer 101, the first through third structure sensors 121 through 123, or the generator 152 is outside the previously determined wind speed range, the controller 100 generates and sends the braking control signal to the first and second guide vanes 131 and 132, the generator 152, or the impeller 110, and transfers the braking control signal to the main braking unit 161 and the auxiliary braking unit 162. The auxiliary braking unit 162 allows or blocks the mechanical interaction between the generator 152 and the transmission gear unit 151 according to the control signal of the controller 100.

The first through third structure sensors 121 through 123 comprise first and second center axis sensors 121 and 122 that are disposed in upper and lower ends of a vertical center axis of the impeller 110, respectively, and measure an inclination of the vertical center axis, and a vane displacement sensor 123 that measures a degree of droop of the vanes 111. The first through third structure sensors 121 through 123 transfer data of the inclination of the vertical center axis and data of the displacement of the vanes 111 to the controller 100.

The first guide vane 131 is fixed to a frame connected to an axis of the impeller 110 by a separate bearing, and rotationally moves by a predetermined angle according to the wind direction under the control of the controller 100. The first guide vane 131 is a curved inlet guide vane and increases or reduces a speed of wind incident to the vanes 111 so as to change the torque of the turbine.

The second guide vane 132 is a lateral side guide vane and assists the function of the first guide vane 131. The second guide vane 132 rotationally moves according to the wind direction and controls the amount of wind incident to the vanes 111 so as to increase or reduce the speed of the incident wind.

The operation of the apparatus for controlling a vertical axis wind power generation system of the present embodiment will now be described with reference to FIGS. 2 through 14.

Referring to FIG. 2, the controller 100 performs a calculation according to the information received from the anemoscope/anemometer 101 and the first through third structure sensors 121 through 123, and drives or releases the generator 152, the first and second guide vane driving/braking units 141 and 142, the main braking unit 161, and the auxiliary braking unit 162.

If a current wind speed received from the anemoscope/anemometer 101 is low, since power cannot be generated by driving the generator 152 by the rotational power of the impeller 110, the controller 100 stops the first and second guide vane driving/braking units 141 and 142, drives the main braking unit 161 and the auxiliary braking unit 162, and stops the generator 152, the transmission gear unit 151, and the impeller 110.

If the current wind speed received from the anemoscope/anemometer 101 is high, overload can occur in the generator 152 due to the rotational power generated by the rotation of the impeller 110 in connection with the gear 151a of the impeller 110, the transmission gear unit 151, and the generator 152. In this case, the controller 110 drives the main braking unit 161 and the auxiliary braking unit 162, stops the generator 152, the transmission gear unit 151, and the impeller 110, controls the first and second guide vane driving/braking units 141 and 142 in order to reduce the rotational energy of the impeller 110, and stops the first guide vane 131 and the second guide vane 132, so that the generator 152 is mechanically and electrically separated from the vertical wind power turbine.

When the current wind speed received from the anemoscope/anemometer 101 maintains a predetermined level capable of generating wind power, the controller 100 calculates a main wind direction based on information about the wind direction received from the anemoscope/anemometer 101 and drives the first and second guide vane driving/braking units 141 and 142 in order to produce the maximum efficiency of the impeller 110, so that the first guide vane 131 and the second guide vane 132 can move to an optimal position according to the main wind direction, and thus the generator 152 can generate the maximum power.

Meanwhile, when the power of the generator 152 exceeds the rated power due to a delayed reaction of the first and second guide vane driving/braking units 141 and 142 to a rapid change in wind speed, the controller 100 directly controls the main braking unit 161 and brakes the gear 151a and the transmission gear unit 151, thereby reducing the power of the generator 152.

In more detail, if the current wind speed exceeds a rated wind speed, the amount of wind passing over the impeller 110 must be reduced by turning the first and second guide vanes 131 and 132 in order to maintain a rated rotation speed of the generator 152. However, since the first and second guide vanes 131 and 132 have a low rotation speed, the wind passing over the impeller 110 cannot be properly blocked, and thus it is difficult to control the status of the generator 152. At this time, the main braking unit 161 is used to incur an energy loss in order to reduce the energy transferred to the generator 152.

The first through third structure sensors 121 through 123 are installed in structures and transmit information on the displacements of the structures to the controller 100. The first and second structure sensors 121 and 122 are the first and second center axis sensors that are fixed to upper and lower ends of the vertical center axis of the impeller 110 and transmit the inclination data of the impeller 110 to the controller 100. The third structure sensor 123 is a vane displacement sensor that is disposed on an end tip of the vanes 111, measures the degree of droop of the vanes 111, and transmits the displacement data of the vanes 111 to the controller 100.

The controller 100 carries out a calculation operation using the information received from the first through third structure sensors 121 through 123 in order to predict structural damage and, if the structural damage is predicted, stops all functions of the vertical axis wind power generation system.

Also, when an excessive current flows in the generator 152 or the generator 152 erroneously operates, since the transmission gear unit 151, the impeller 110, and the vanes 111 may be damaged, the controller 100 drives the main braking unit 161 and the auxiliary braking unit 162 and stops the generator 152, the transmission gear unit 151, the impeller 110, and the vanes 111.

If the impeller 110 rotates, the gear 151a that is disposed in the lower end of a rotational center axis of the impeller 110 rotates, and the rotation power of the gear 151a is transferred to the transmission gear unit 151.

The transmission gear unit 151 coupled to the gear 151 a is a gearbox that shifts gears according to the number of rotations and is based on a coupling gear ratio, transfers the rotational power to the generator 152, thereby generating the wind power.

The rotational power transferred from the transmission gear unit 151 is output by the generator 152 as generated wind power, and then the generated power passes through an electric power transmission system. The generator 152 controls the power generation status according to a control instruction of the controller 100 and transmits whether to perform power generation to the controller 100. Sensors (not shown) installed in the generator 152 check a current status and operation status, and, when excessive current flows in the generator 152 or the generator 152 erroneously operates, the sensors transmit such information to the controller 100.

The first and second guide vane driving/braking units 141 and 142 receive a position movement control signal of the first and second guide vanes 131 and 132 regarding the wind direction from the controller 100 and move the first and second guide vanes 131 and 132 in order to maintain the optimum rotation speed of the impeller 110. Thereafter, the first and second guide vane driving/braking units 141 and 142 transmit result data to the controller 100.

Meanwhile, sensors (not shown) sensing an operation status are installed in the first and second guide vane driving/braking units 141 and 142, and, if an excessive current flows in the first and second guide vane driving/braking units 141 and 142 or the first and second guide vane driving/braking units 141 and 142 erroneously operate, the first and second guide vane driving/braking units 141 and 142 may be damaged, and thus the sensors transmit such information to the controller 100.

The anemoscope/anemometer 101, the first and second guide vane driving/braking units 141 and 142, the generator 152, the main braking unit 161, the auxiliary braking unit 162, and the first through third structure sensors 121 through 123 transmit information about each operation status to the controller 100. The controller 100 transmits the received information to the server 200. The server 200 stores and displays the received information, and, if necessary, monitors and controls the whole vertical wind power generation system in a remote area via the controller 100.

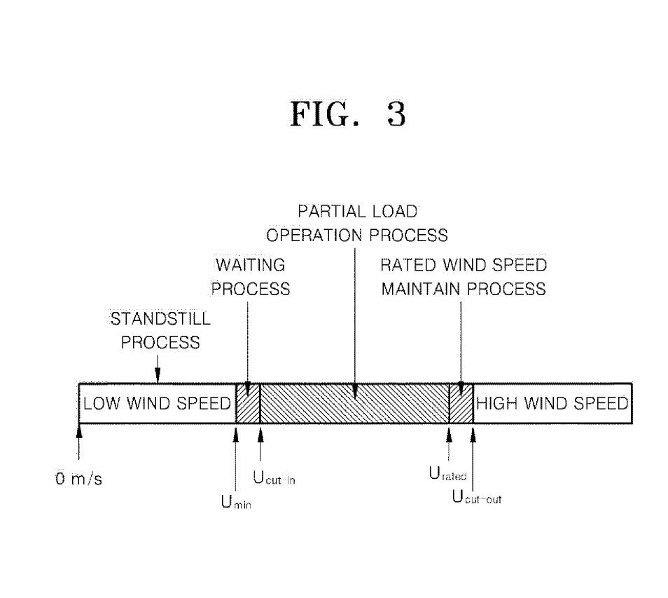

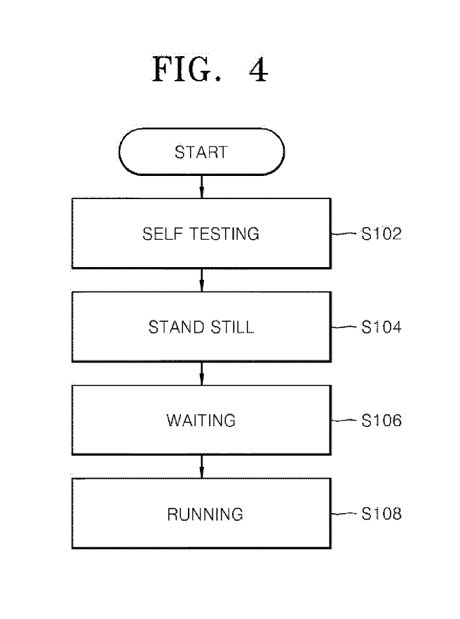

FIG. 3 is a diagram of an operation process according to a wind speed in the vertical axis wind power generation system according to an embodiment of the present invention. FIG. 4 is a schematic flowchart illustrating a process of controlling the vertical axis wind power generation system according to an embodiment of the present invention.

Referring to FIG. 3, Uₘᵢₙ denotes a value of a minimum wind speed for preparing for the driving of a generator and is established in a controller. U_{cut-in} denotes an established value of the minimum wind speed for starting the power generation. U_{rated} denotes an established value of a wind speed at which the rated power is generated in the power generation system. U_{cut-out} denotes an established value of a maximum wind speed at which the power generation is stopped.

Referring to FIG. 4, the controller 100 of the vertical axis wind power generation system performs self-testing with regard to each unit thereof (step 102). In the self testing process (step 102), the main braking unit 161 and the auxiliary braking unit 162 are turned on and the operation status of each unit is checked.

Before the self testing process (step 102) is performed, the controller 100 tests the operation status of the main braking unit 161 and the auxiliary braking unit 162, gives a return-to-origin instruction to the first and second guide vanes 131 and 132, checks whether the return-to-origin instruction is performed, and checks the operation status of the generator 152.

If an error is detected as a result of self-testing, the main braking unit 161 and the auxiliary braking unit 162 remain turned ON and an alert is generated. If no error is detected as a result of self-testing, a standstill process is performed (step 104).

The standstill process (step 104) is performed when a current wind speed U received from the anemoscope/anemometer 101 to the controller 100 is lower than the minimum wind speed Uₘᵢₙ or is higher than the maximum wind speed U_{cut-out}.

A waiting process is performed (step 106) when the current wind speed U is higher than the minimum wind speed Uₘᵢₙ for preparing for the driving of the power generation and is lower than the minimum wind speed U_{cut-in} for starting the power generation.

A running process is performed (step 108) when the current wind speed U received by the controller 100 is higher than the minimum wind speed U_{cut-in} for starting the power generation and is lower than the maximum wind speed U_{cut-out} for stopping the power generation.

In the running process (step 108), a partial load operation is performed to increase power until the current wind speed reaches the rated wind speed U_{rated} for outputting the rated power, and, after the output power of the generator 152 reaches the rated output power, a rated power maintaining process is performed so that the speed of wind passing over the impeller 110 can be maintained at the rated wind speed (i.e., the output power of the generator 152 can continuously maintain the rated output power).

When the current wind speed U exceeds the maximum wind speed U_{cut-out} for stopping the power generation, the current wind speed U is determined to be a high wind speed and the vertical axis wind power generation system enters a stop mode.

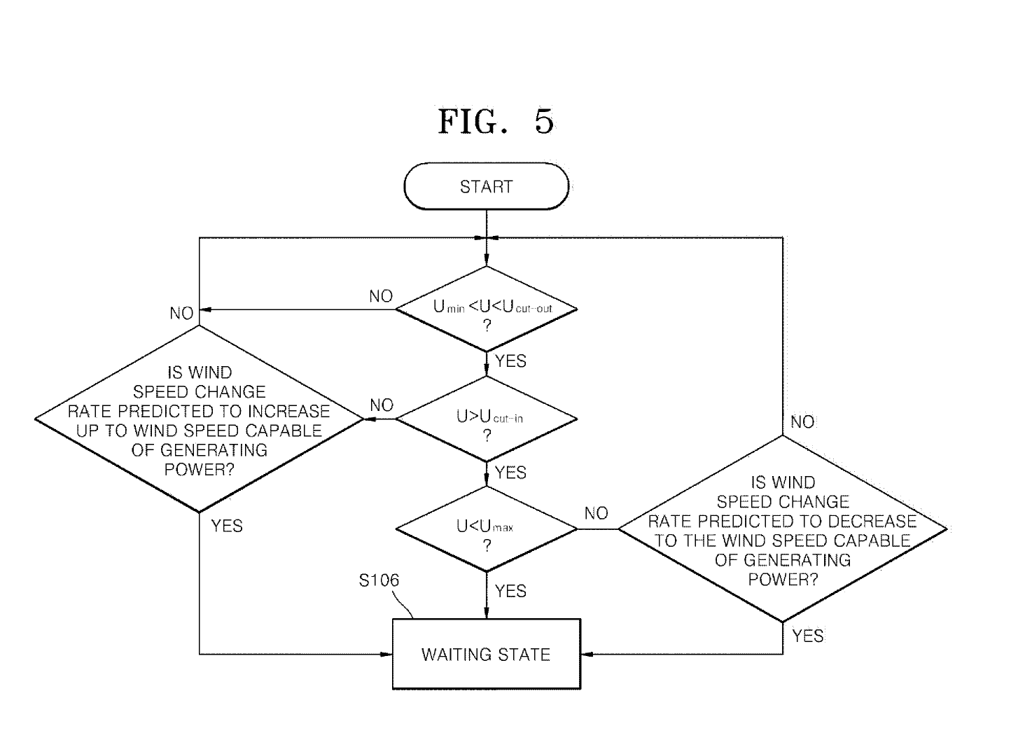

Each operation shown in FIG. 4 will now be described in detail with reference to FIGS. 5 through 14.

FIG. 5 is a detailed flowchart illustrating the standstill process (step 104) shown in FIG. 4. Referring to FIG. 5, the standstill process is performed when the current wind speed U is lower than the minimum wind speed Uₘᵢₙ or is higher than the maximum wind speed U_{cut-out} for stopping the power generation. At this time, the main braking unit 161 and the auxiliary braking unit 162 are turned ON to perform a braking operation, and the generator 152 is separated from the wind power turbine and its load.

When the current wind speed U received by the controller 100 is higher than the minimum wind speed Uₘᵢₙ and is lower than minimum wind speed U_{cut-in} for starting the power generation, an increase in a wind speed change rate (du/dt) per second is calculated, and if the wind speed change per second is predicted to result in an established wind speed capable of generating power, the waiting process (step 106) is performed. If the current wind speed U is higher than the maximum wind speed Uₘₐₓ for preparing for the stopping of the generator 152 and a reduction in the wind speed change rate (du/dt) per second is predicted to result in the established wind speed capable of generating power, the waiting process (step 106) is performed.

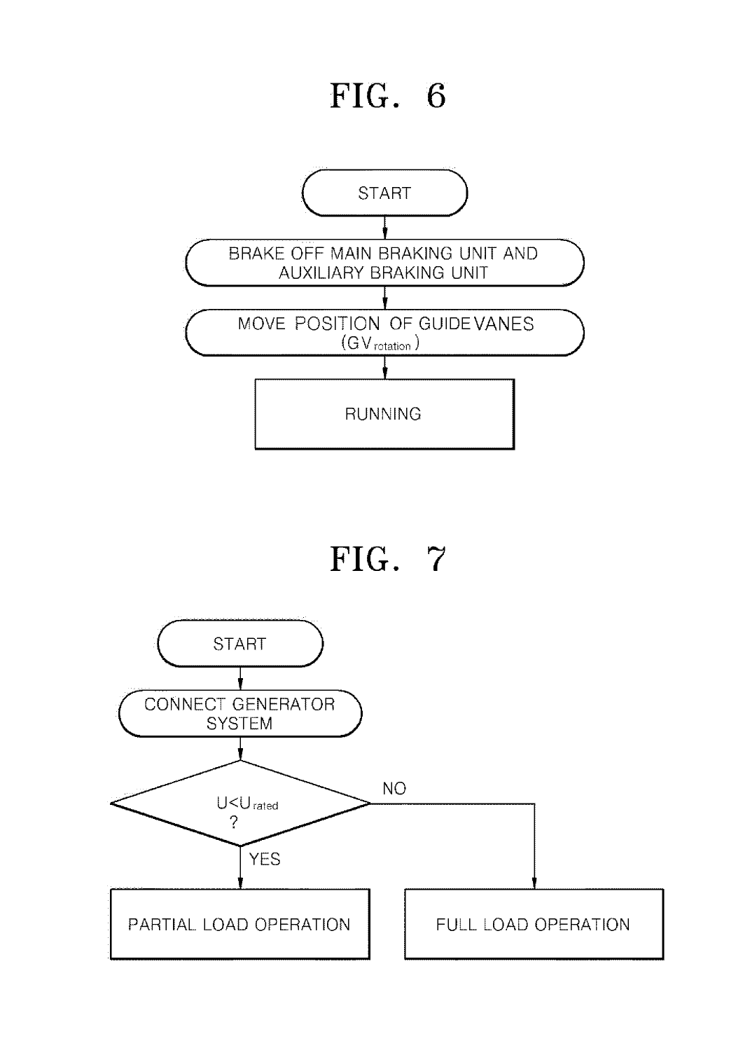

FIG. 6 is a detailed flowchart illustrating the waiting process (step 106) shown in FIG. 4. Referring to FIG. 6, in the waiting process (step 106), the main braking unit 161 and the auxiliary braking unit 162 are released from a braking status, the first and second guide vanes 131 and 132 drive the first and second guide vane driving/braking units 141 and 142 at a predetermined time interval established by the controller 100 and moves the first and second guide vane driving/braking units 141 and 142 according to a main wind direction, so that the maximum amount of wind can pass over the impeller 110.

During the waiting process, the power generation starts when the current wind speed U reaches the minimum wind speed U_{cut-in} for starting the power generation.

FIG. 7 is a detailed flowchart illustrating the running process (step 108) shown in FIG. 4. Referring to FIG. 7, in the running process (step 108) in which the generator 152 is driven, the generator 152 is coupled to the transmission gear unit 151 and is excited in order to perform power generation, and the partial load operation or a full load operation is performed according to the wind speed.

Based on the rated wind speed U_{rated} for the rated power generated by the generator 152, if the current wind speed U is lower than the rated wind speed U_{rated}, the partial load operation is performed, and if the current wind speed U is higher than the rated wind speed U_{rated}, the full load operation is performed.

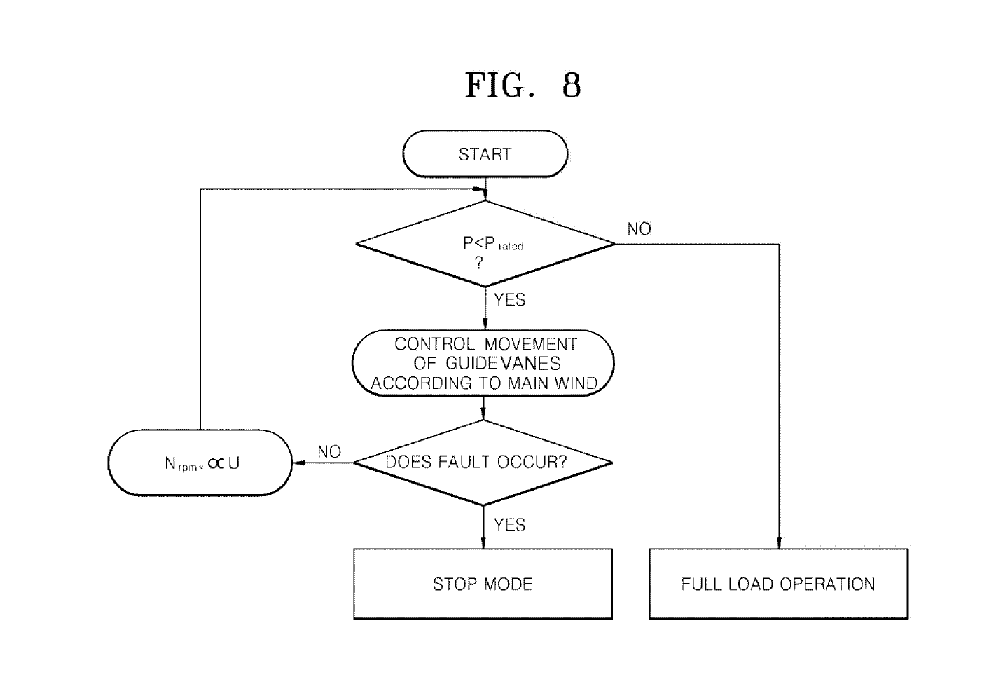

FIG. 8 is a detailed flowchart illustrating the partial load operation shown in FIG. 7. In the partial load operation, load power varies according to a wind speed. Referring to FIG. 8, if current power P generated by the current wind speed U is smaller than rated power P_{rated}, the first and second guide vanes 131 and 132 are moved in accordance with a main wind direction, so that the maximum amount of wind can flow over the impeller 110.

In more detail, the current wind speed U of the vertical axis wind power generation system continuously varies. During the partial load operation, a rotation speed N_{rpm*} is maintained until the rated power P_{rated} is generated, in proportion to the current wind speed U in order to generate the maximum power. If the rated power P_{rated} is generated according to an increase in the current wind speed U, the full load operation is performed.

When a fault occurs due to, for example, an excessive current, a high wind speed, an emergency status, structural faults, or any other malfunctions, the vertical axis wind power generation system enters the stop mode.

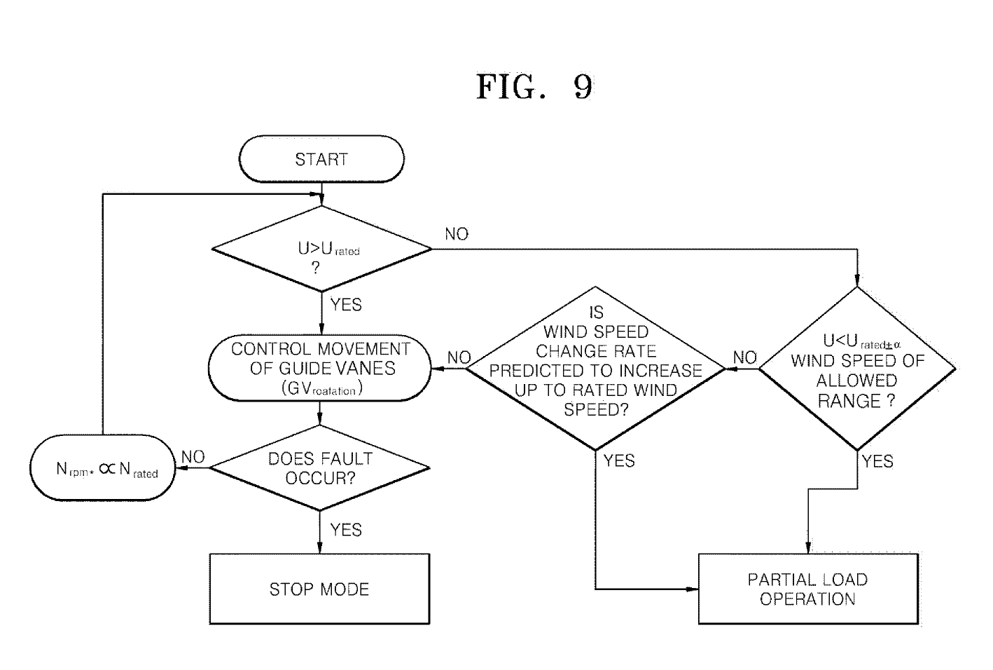

FIG. 9 is a detailed flowchart illustrating the full load operation shown in FIG. 7. The full load operation is subsequent to the partial load operation, and maintains the full output power irrespective of the current wind speed U.

Referring to FIG. 9, since during the full load operation the current wind speed U is higher than the rated wind speed U_{rated}, in order to reduce excessive power caused by an excessive wind speed, position movement values of the first and second guide vanes 131 and 132 are determined and then the positions of the first and second guide vanes 131 and 132 are moved so that the amount of wind passing over the impeller 110 is reduced.

The first and second guide vanes 131 and 132 are used to reduce an excessive wind pressure, thereby maintaining the rotation speed Nᵣₚₘ of the generator 152 as a rated rotation speed N_{rated}.

Meanwhile, when the current wind speed U is lower than the rated wind speed U_{rated} and is lower than a rated allowed wind speed range U_{rated±α}, and the wind speed change rate (du/dt) is greater than an established allowed value, it is determined that the current wind speed U exceeds the rated wind speed U_{rated}, and the positions of the first and second guide vanes 131 and 132 are moved in order to reduce the amount of the wind incident to the impeller 110.

When the current wind speed U is lower than a rated allowed wind speed range U_{rated±α}, and the wind speed change rate (du/dt) is smaller than an established allowed value, it is determined that the current wind speed U does not exceed the rated wind speed U_{rated}, and thus the partial load operation is subsequently performed.

When a fault occurs due to, for example, an excessive current, a high wind speed, an emergency status, structural faults, or any other malfunctions, the vertical axis wind power generation system enters the stop mode.

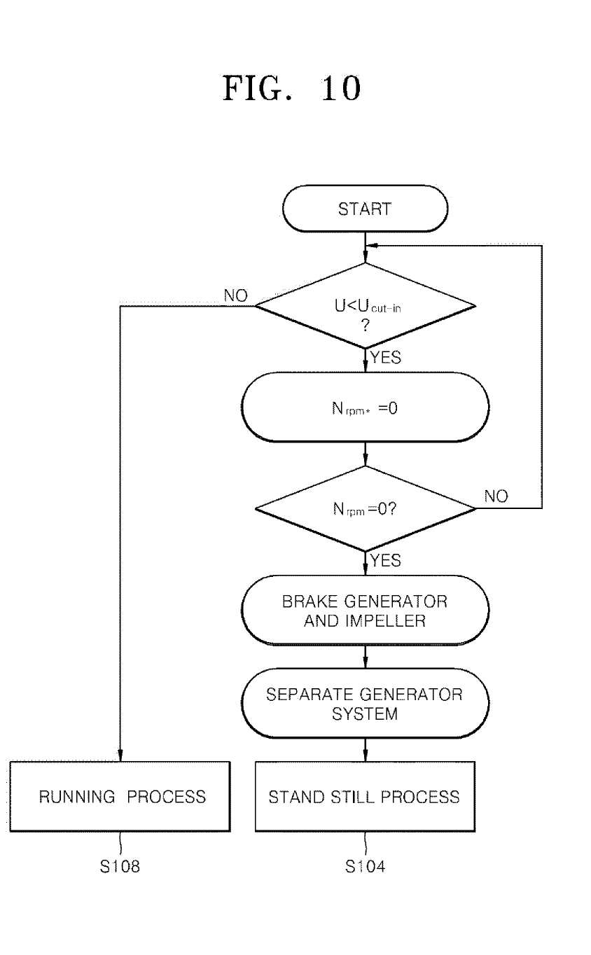

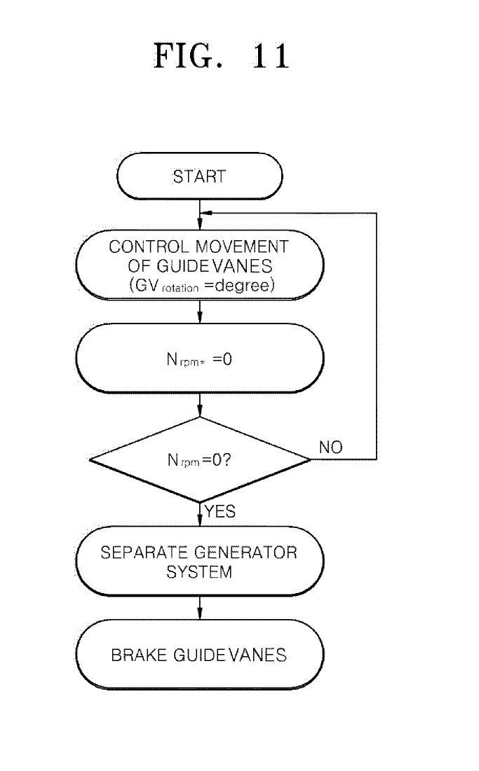

FIGS. 10 through 14 are flowcharts illustrating the operation of the vertical axis wind power generation system in a stop mode when a fault occurs due to, for example, an excessive current, a high wind speed, an emergency status, structural faults, or any other malfunctions, during a waiting or running status of the vertical axis wind power generation system.

In the self testing process (step 102) shown in FIG. 4, the stop mode can be entered while the partial load operation or the full load operation (see FIG. 7) is performed. The stop mode can be classified into a fault stop mode in which the fault occurs and the operation of the vertical axis wind power generation system stops, and an emergency stop mode in which the operation of the vertical axis wind power generation system stops in order to protect the vertical axis wind power generation system in an emergency state where the vertical axis wind power generation system may be damaged due to a very high wind speed. The vertical axis wind power generation system of the present invention can selectively enter the fault stop mode or the emergency stop mode according to each state.

Referring to FIG. 10, with regard to the operation of the vertical axis wind power generation system in the fault stop mode, when the current wind speed U received by the controller 100 is lower than the minimum wind speed U_{cut-in} for starting the power generation, the vertical axis wind power generation system enters a low wind speed stop mode. Then, if a displacement amount of the structures received from the first through third structure sensors 121 through 123 that measure displacement of the structures is within a previously established range, the vertical axis wind power generation system enters a guide vane stop mode that stops the first and second guide vanes 131 and 132. When a fault signal is received from the main braking unit 161 and the auxiliary braking unit 162, the vertical axis wind power generation system enters a braking unit stop mode.

With regard to the emergency stop mode, if the current wind speed U received by the controller 100 is higher than the maximum wind speed U_{cut-out} for stopping the power generation, the vertical axis wind power generation system enters a high wind speed stop mode in order to protect the vertical axis wind power generation system.

When a fault signal is received from the generator 152, the vertical axis wind power generation system enters a generator stop mode. If the displacement amount of the structures received from the first through third structure sensors 121 through 123 is outside the previously established range, the vertical axis wind power generation system enters the same stop mode as the generator stop mode. When a fault signal indicating a fault in the first and second guide vanes 131 and 132 is received, the vertical axis wind power generation system enters the guide vane stop mode.

The detailed operation of each stop mode will now be described with reference to FIGS. 10 through 14.

FIG. 10 is a flowchart illustrating a method of controlling a vertical axis wind power generation system in a low wind speed stop mode according to an embodiment of the present invention. Referring to FIG. 10, in a low wind speed stop mode, when the current wind speed U is lower than the minimum wind speed U_{cut-in} for starting the power generation, the standstill process (step 104) shown in FIG. 4 is performed.

In more detail, if the current wind speed U is lower than the minimum wind speed U_{cut-in} for starting the power generation, the controller 100 gives an instruction (N_{rpm*}=0) to stop the rotation of the generator 152 so that electrical braking is applied to the generator 152 and it is slowly stopped. The main braking unit 161 and the auxiliary braking unit 162 are used to brake each unit of the vertical axis wind power generation system, separate the generator system from the wind power turbine, and then the standstill process (step 104) is performed.

FIG. 11 is a flowchart illustrating a method of controlling a vertical axis wind power generation system in a braking unit stop mode according to an embodiment of the present invention. Referring to FIG. 11, the vertical axis wind power generation system enters the braking unit stop mode when a brake pad (not shown) of the main braking unit 161 and the auxiliary braking unit 162 deteriorates or a hydraulic pump or a hydraulic motor (not shown) operates for more than a predetermined period of time.

The first and second guide vanes 131 and 132 are moved by a predetermined angle so as to minimize the amount of wind passing over the impeller 110, and electrical braking is applied to the generator 152 according to the stop instruction (N_{rpm*}=0) of the controller 100. If the generator 152 stops, the generator 152 and the impeller 110 are mechanically disconnected, and braking is applied to the first and second guide vanes 131 and 132.

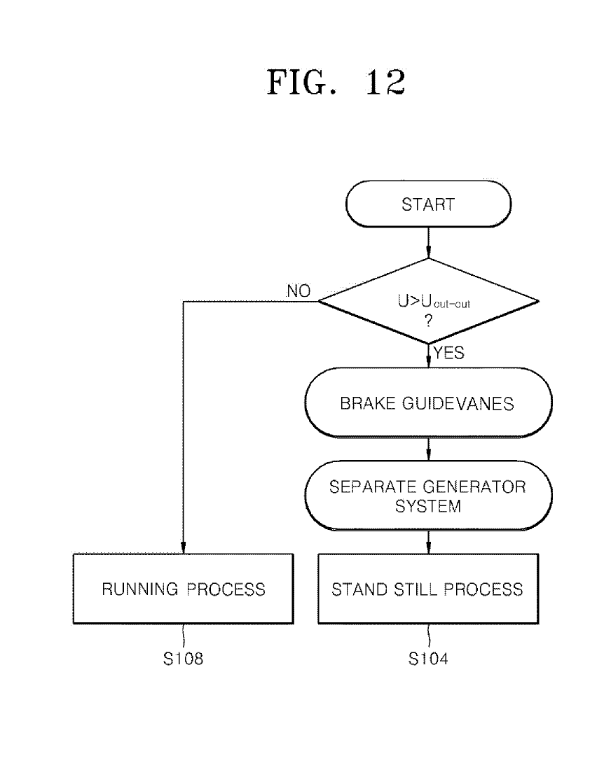

FIG. 12 is a flowchart illustrating a method of controlling a vertical axis wind power generation system in a high wind speed stop mode according to an embodiment of the present invention. The high wind speed stop mode is the emergency stop mode in which a sudden large mechanical stress is predicted, and thus the vertical axis wind power generation system must stop as quickly as possible.

Referring to FIG. 12, in the high wind speed stop mode, if the current wind speed U is higher than the maximum wind speed U_{cut-out} for stopping the power generation, the controller 100 moves the first and second guide vanes 131 and 132 by a predetermined angle, thus minimizing the amount of the wind passing over the impeller 110, brakes the first and second guide vanes 131 and 132, and mechanically disconnects the generator 152 and the impeller 110, and the standstill process (step 104) is performed.

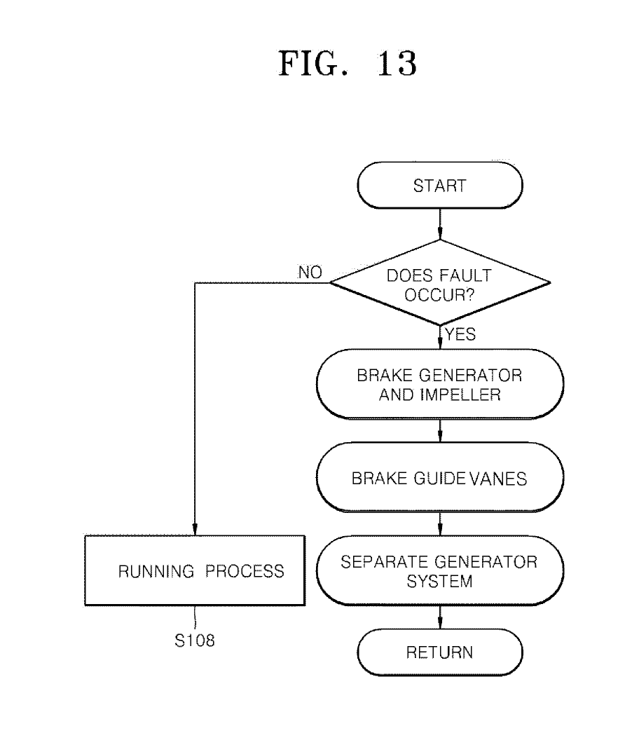

FIG. 13 is a flowchart illustrating a method of controlling a vertical axis wind power generation system in a generator stop mode when a malfunction such as an excessive current occurs in the generator 152 or when a structure displacement value received from the first through third structure sensors 121 through 123 is outside a previously established range according to an embodiment of the present invention. Referring to FIG. 13, when an electric fault occurs during a running mode (partial load running and full load running) due to, for example, an excessive current flow in the generator 152 or the structure displacement value received from the first through third structure sensors 121 through 123 being outside the previously established range, it is determined as a dangerous status. The controller 100 drives the first braking unit 161 and the auxiliary braking unit 162 to brake the generator 152 and the impeller 110 and to brake the first and second guide vanes 131 and 132, and then mechanically disconnects the generator 152 and the impeller 110.

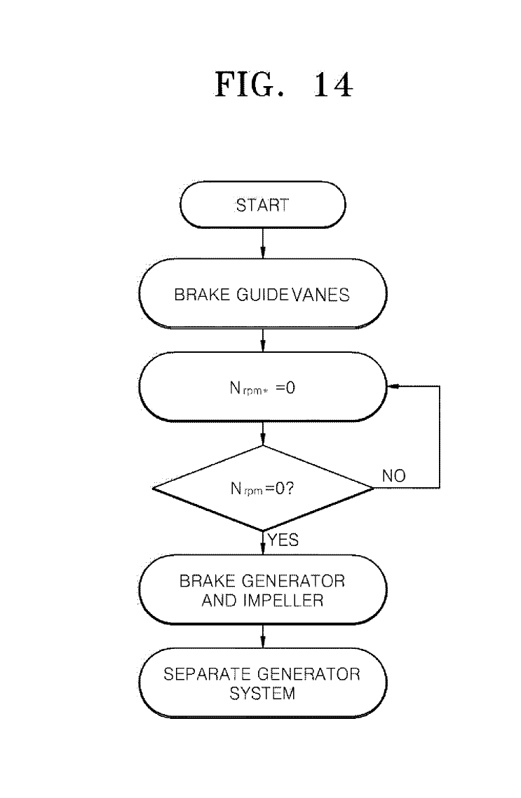

FIG. 14 is a flowchart illustrating a method of controlling a vertical axis wind power generation system in a guide vane stop mode according to an embodiment of the present invention. Referring to FIG. 14, when a fault occurs due to, for example, an excessive current flow in the first and second guide vane driving/braking units 141 and 142 or power not being applied thereto, since the generator 152 is not influenced by the fault, the first and second guide vanes 131 and 132 are immediately stopped, whereas the generator 152 is slowly stopped.

In more detail, when the fault occurs in the first and second guide vane driving/braking units 141 and 142, braking is applied to the first and second guide vanes 131 and 132, and electrical braking is applied to the generator 152 by receiving the stop instruction (N_{rpm*}=0). If the generator 152 is stopped, the main braking unit 161 and the auxiliary braking unit 162 are driven, braking is applied to the impeller 110 and the generator 152, and the generator 152 and the impeller 110 are mechanically disconnected.

As described above, the apparatus and method for controlling the vertical axis wind power generation system according to the present invention can rotationally control the guide vanes according to wind direction and speed, and appropriately adjust a direction of wind passing over an impeller, thereby maintaining a rotation speed for generating the maximum power, so that efficient power generation is possible at a low wind speed.

Also, the apparatus and method for controlling the vertical axis wind power generation system according to the present invention can check the output power of a generator according to wind direction and speed, maintain rated power, and stop the generator when a low or high wind speed outside a setting value range, an error in a structure, a fault in a braking unit, and/or a fault in guide vanes are detected, thereby protecting the vertical axis wind power generation system.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for controlling a vertical axis wind power generation system comprising an anemoscope/anemometer that measures a wind direction and speed, a vertical impeller having a plurality of vanes, one or more guide vanes that guide incident wind and makes the wind flow over the impeller, and a generator that generates power by the rotation of the impeller due to the wind, and for controlling an amount of the wind incident to the impeller based on data received from the anemoscope/anemometer, the apparatus comprising:
one or more structure sensors sensing displacements of structures supporting each of a plurality of units of the vertical axis wind power generation system;
guide vane driving/braking units rotation-driving or braking the one or more guide vanes and controlling the amount of the wind incident to the impeller;
a controller receiving data of the wind direction and speed from the anemoscope/anemometer, sending a signal for controlling the one or more guide vanes to the guide vane driving/braking units so that the generator can generate a previously determined maximum power, and, if each piece of data received from the anemoscope/anemometer, the one or more structure sensors, or the generator is outside a previously established value range, generating a braking signal in the one or more guide vanes, the generator, or the impeller or generating a control signal for mechanically connecting or disconnecting the generator and the impeller; and
one or more braking units stopping the generator, the impeller, and the guide vanes according to the control signal for stopping the generator, the control signal for stopping the impeller, or the control signal for stopping the one or more guide vanes that are received from the controller.

2. The apparatus of claim 1, wherein the one or more structure sensors comprise first and second center axis sensors that are disposed in upper and lower ends of a vertical center axis of the impeller, respectively, and a vane displacement sensor that is disposed in an end tip of the vanes of the impeller and measures a degree of droop of the vanes,
wherein each of the first and second center axis sensors and the vane displacement sensor transfer data about the inclination of the vertical center axis and data about the displacement of the vanes to the controller.

3. The apparatus of claim 1, wherein the one or more guide vanes comprise inlet guide vanes and lateral side guide vanes, and the guide vane driving/braking units rotate the inlet guide vanes and the lateral side guide vanes according to the control signals of the controller and move positions of the inlet guide vanes and lateral side guide vanes or brake the inlet guide vanes and lateral side guide vanes.

4. The apparatus of claim 1, wherein the controller outputs a braking control signal when a current wind speed is low or high and outside a previously determined wind speed range according to the data of the wind speed received by the controller from the anemoscope/anemometer, when the data about displacements of structures received by the controller from the one or more structure sensors exceeds an established value, or when an excessive current flow in the generator or a malfunction of the generator is detected according to data received by the controller from the generator,
wherein the braking control signal that is selectively applied to the one or more guide vanes, the generator, or the impeller, is used to brake the one or more guide vanes, the generator, or the impeller, and is used to mechanically disconnect the generator and the impeller.

5. The apparatus of claim 4, wherein the controller generates the control signal for braking the generator and the impeller when the wind speed received from the anemoscope/anemometer is low or high and outside the previously determined wind speed range, or when the malfunction of the generator or an excessive displacement of structures is detected, and
the controller generates the control signal for braking the one or more guide vanes when the wind speed received from the anemoscope/anemometer is high and outside the previously determined wind speed range, a malfunction of the one or more braking units occurs, the malfunction of the generator occurs, the excessive displacement of structures is detected, or a malfunction of the guide vane driving/braking units occurs.

6. The apparatus of claim 1, wherein the controller outputs the braking control signal with regard to at least one of a main braking unit that controls the rotation of the impeller, an auxiliary braking unit that controls the driving of the generator, and the guide vane driving/braking units that brake the one or more guide vanes.

7. The apparatus of claim 1, further comprising a server that remotely receives status data of each unit received by the controller and control instruction data output by the controller, stores and monitors the status data and the control instruction data,
wherein the server can perform remote control through the controller.

8. A method of controlling a vertical axis wind power generation system that guides incident wind to a vertical axis impeller by receiving current data of a wind direction and speed measured by an anemoscope/anemometer, calculating the current data, and controlling a position movement of one or more guide vanes in a controller, drives a generator by the rotation power of the impeller rotating due to the incident wind, and generates power, the method comprising:
a standstill process of, when a current wind speed is lower than a minimum wind speed for preparing for the driving of the generator or is higher than a maximum wind speed for stopping the power generation according to the data of the wind speed received by the controller from the anemoscope/anemometer, braking the one or more guide vanes, the impeller or the generator wherein the controller performs the braking, and mechanically disconnecting the generator and the impeller;
a waiting process of, when the current wind speed received by the controller is maintained between a minimum wind speed for starting the power generation and a maximum wind speed for preparing for the stopping of the generator, braking the one or more guide vanes, the impeller or the generator, and moving the one or more guide vanes in accordance with a main wind direction, so that wind having the highest efficiency can flow over the impeller;
a partial load operation process, after the waiting process, of mechanically connecting the generator and the impeller, and, when the current wind speed is lower than a wind speed for generating rated power, moving the one or more guide vanes in accordance with the main wind direction so as to generate the maximum power at the current wind speed;
a full load operation process of, when the power generated by the generator is higher than the rated power, moving the one or more guide vanes and limiting the wind flowing over the impeller so as to maintain the rated power; and
a stopping process of, when the controller detects a fault in at least one of a plurality of units or when the current wind speed is not maintained between the minimum wind speed for preparing for the driving of the generator and the maximum wind speed for stopping the power generation during each process, entering a stop mode in which each unit is stopped.

9. The method of claim 8, further comprising: a self-testing process before the standstill process,
wherein the self-testing process comprises:
testing a braking operation status of the generator, the impeller, and the one of more guide vanes wherein the controller performs the testing;
testing an operation status of one or more braking units;
testing the driving of the one or more guide vanes by generating a return-to-origin control signal for the one or more guide vanes;
testing the operation and generation status of the generator; and
if a fault occurs during any one of the testing processes, entering the stop mode and generating an alert.

10. The method of claim 8, wherein, when the current wind speed is lower than the minimum wind speed for starting the generation of the generator and is predicted to increase up to a wind speed value capable of generating the power, determined by calculating a wind speed change rate per second during the standstill process, proceeding to the waiting process,
when the current wind speed is higher than the maximum wind speed for preparing for the stopping of the generator and is predicted to decrease down to the wind speed value capable of generating the power, determined by calculating the wind speed change rate per second, proceeding to the waiting process.

11. The method of claim 8, wherein the partial load operation process comprises:
moving positions of the one or more guide vanes by a predetermined angle according to the main wind direction;
increasing the rotation speed of the generator according to an increase in the current wind speed;
repeatedly performing the moving of positions of the one or more guide vanes and the increasing of the rotation speed of the generator and, if the power output by the generator becomes the rated power, proceeding to the full load operation process; and
if a fault is detected during the partial load operation process, entering the stop mode.

12. The method of claim 8, wherein the full load operation process comprises:
when the current wind speed received by the controller is higher than a rated wind speed, calculating a position movement value of the one or more guide vanes in order to reduce an excessive power generated by an excessive wind speed, controlling the positions of the one or more guide vanes, reducing an amount of the wind flowing over the impeller, and maintaining the rotation speed of the generator at the rated rotation speed;
when the current wind speed is lower than the rated wind speed, is lower than a wind speed of a rated allowing range, and is predicted to increase up to the rated wind speed according to the wind speed change rate value, performing the controlling of the locations of the one or more guide vanes, the reducing of the amount of the wind flowing over the impeller, and the maintaining of the rotation speed of the generator as the rated rotation speed;
when the current wind speed is lower than the wind speed of the rated allowing range or is not predicted to increase up to the rated wind speed according to the wind speed change rate value, proceeding to the partial load operation process; and
entering the stop mode when a fault occurs when the controlling of the positions of the one or more guide vanes, the reducing of the amount of the wind flowing over the impeller, and the maintaining of the rotation speed of the generator as the rated rotation speed are performed.

13. The method of claim 8, wherein the stopping process is performed by braking at least one of the generator, the one or more guide vanes, and the impeller, under the control of the controller.

14. The method of claim 8, wherein the stop mode comprises a fault stop mode and an emergency stop mode, and one of the fault stop mode and the emergency stop mode is selected in the stop mode,
wherein the fault stop mode comprises a low wind speed stop mode in which the current wind speed received by the controller is lower than the minimum wind speed for starting the generation; a guide vane stop mode in which a structure displacement value received by the controller from one or more structure sensors is within a previously established range; and a braking unit stop mode in which a braking fault signal is received from a main braking unit and an auxiliary braking unit, which brake the impeller and the generator, and one or more guide vane driving/braking units,
wherein the emergency stop mode comprises a high wind speed stop mode in which the current wind speed received by the controller is higher than a maximum wind speed for stopping the generator; a generator stop mode in which a fault signal of the generator is received and the structure displacement value received by the controller from one or more structure sensors that measure displacements of structures is outside a previously established range; and a guide vane stop mode in which a fault signal is received from the one or more guide vanes.

15. The method of claim 9, wherein the stop mode comprises a fault stop mode and an emergency stop mode, and one of the fault stop mode and the emergency stop mode is selected in the stop mode,
wherein the fault stop mode comprises a low wind speed stop mode in which the current wind speed received by the controller is lower than the minimum wind speed for starting the generation; a guide vane stop mode in which a structure displacement value received by the controller from one or more structure sensors is within a previously established range; and a braking unit stop mode in which a braking fault signal is received from a main braking unit and an auxiliary braking unit, which brake the impeller and the generator, and one or more guide vane driving/braking units,
wherein the emergency stop mode comprises a high wind speed stop mode in which the current wind speed received by the controller is higher than a maximum wind speed for stopping the generator; a generator stop mode in which a fault signal of the generator is received and the structure displacement value received by the controller from one or more structure sensors that measure displacements of structures is outside a previously established range; and a guide vane stop mode in which a fault signal is received from the one or more guide vanes.

16. The method of claim 10, wherein the stop mode comprises a fault stop mode and an emergency stop mode, and one of the fault stop mode and the emergency stop mode is selected in the stop mode,
wherein the fault stop mode comprises a low wind speed stop mode in which the current wind speed received by the controller is lower than the minimum wind speed for starting the generation; a guide vane stop mode in which a structure displacement value received by the controller from one or more structure sensors is within a previously established range; and a braking unit stop mode in which a braking fault signal is received from a main braking unit and an auxiliary braking unit, which brake the impeller and the generator, and one or more guide vane driving/braking units,
wherein the emergency stop mode comprises a high wind speed stop mode in which the current wind speed received by the controller is higher than a maximum wind speed for stopping the generator; a generator stop mode in which a fault signal of the generator is received and the structure displacement value received by the controller from one or more structure sensors that measure displacements of structures is outside a previously established range; and a guide vane stop mode in which a fault signal is received from the one or more guide vanes.

17. The method of claim 11, wherein the stop mode comprises a fault stop mode and an emergency stop mode, and one of the fault stop mode and the emergency stop mode is selected in the stop mode,
wherein the fault stop mode comprises a low wind speed stop mode in which the current wind speed received by the controller is lower than the minimum wind speed for starting the generation; a guide vane stop mode in which a structure displacement value received by the controller from one or more structure sensors is within a previously established range; and a braking unit stop mode in which a braking fault signal is received from a main braking unit and an auxiliary braking unit, which brake the impeller and the generator, and one or more guide vane driving/braking units,
wherein the emergency stop mode comprises a high wind speed stop mode in which the current wind speed received by the controller is higher than a maximum wind speed for stopping the generator; a generator stop mode in which a fault signal of the generator is received and the structure displacement value received by the controller from one or more structure sensors that measure displacements of structures is outside a previously established range; and a guide vane stop mode in which a fault signal is received from the one or more guide vanes.

18. The method of claim 12, wherein the stop mode comprises a fault stop mode and an emergency stop mode, and one of the fault stop mode and the emergency stop mode is selected in the stop mode,
wherein the fault stop mode comprises a low wind speed stop mode in which the current wind speed received by the controller is lower than the minimum wind speed for starting the generation; a guide vane stop mode in which a structure displacement value received by the controller from one or more structure sensors is within a previously established range; and a braking unit stop mode in which a braking fault signal is received from a main braking unit and an auxiliary braking unit, which brake the impeller and the generator, and one or more guide vane driving/braking units,
wherein the emergency stop mode comprises a high wind speed stop mode in which the current wind speed received by the controller is higher than a maximum wind speed for stopping the generator; a generator stop mode in which a fault signal of the generator is received and the structure displacement value received by the controller from one or more structure sensors that measure displacements of structures is outside a previously established range; and a guide vane stop mode in which a fault signal is received from the one or more guide vanes.

19. The method of claim 14, wherein, in the low wind speed stop mode,
when the current wind speed is lower than the minimum wind speed for preparing for the driving of the generator, generating a signal for stopping the generator and electrically stopping the generator, wherein the controller performs the stopping of the generator;
braking the generator and the impeller; and
mechanically disconnecting the generator and the impeller and proceeding to the standstill process.

20. The method of claim 14, wherein, in the guide vane stop mode,
braking the one or more guide vanes according to a control signal of the controller, and outputting the signal for stopping the generator until the generator is electrically stopped; and
if the generator is electrically stopped, braking the generator and the impeller and mechanically disconnecting the generator and the impeller.

21. The method of claim 14, wherein, in the braking unit stop mode,
moving the one or more guide vanes and blocking the wind from flowing over the impeller;
outputting the signal for stopping the generator and electrically stopping the generator; and
mechanically disconnecting the generator and the impeller and braking the one or more guide vanes.

22. The method of claim 14, wherein, in the high wind speed stop mode,
when the current wind speed is higher than the maximum wind speed for stopping the power generation, moving the one or more guide vanes by a predetermined angle, blocking the wind from flowing over the impeller, and braking the one or more guide vanes; and
mechanically disconnecting the generator and the impeller and proceeding to the standstill process.

23. The method of claim 14, wherein, in the generator stop mode,
when the fault signal of the generator is received or the structure displacement value received by the controller from one or more structure sensors that measure displacements of structures is outside the previously established range, braking the impeller, the generator, and the one or more guide vanes, and mechanically disconnecting the generator and the impeller.
